(19) United States
(12) Patent Application Publication
(10) Pub. No.: US 2025/0024275 A1
(43) Pub. Date: Jan. 16, 2025

(54) METHOD FOR CONFIGURING OR RECONFIGURING PRIMARY CELL, TERMINAL, AND NETWORK DEVICE

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/899,320

(22) Filed: Sep. 27, 2024

Related U.S. Application Data
(63) Continuation of application No. PCT/CN2022/084662, filed on Mar. 31, 2022.

(51) Int. Cl. H04W 24/02; H04W 72/0457; H04W 72/1268; H04W 72/231

(52) U.S. Cl. CPC H04W 24/02; H04W 72/0457; H04W 72/1268; H04W 72/231

(57) ABSTRACT

Provided is a method for configuring or reconfiguring a primary cell, which relates to the field of wireless communications. The method is applicable to a terminal, and includes: receiving a first message; and configuring or reconfiguring the primary cell of the terminal from a first cell to a second cell based on the first message.

### CROSS-REFERENCE TO RELATED APPLICATION

This application is a continuation application of international application No. PCT/CN2022/084662, filed on Mar. 31, 2022, the disclosure of which is incorporated herein by reference in its entirety.

### TECHNICAL FIELD

The present disclosure relates to the field of mobile communications, and in particular, relates to a method and apparatus for configuring or reconfiguring a primary cell, a device, and a medium.

### BACKGROUND

Energy consumption has become an important part of the operator's operational expenditure (OPEX). According to the report from the Global System for Mobile Communications Association (GSMA), the energy cost of the mobile network accounts for about 23% of the total operational expenditure. Most energy consumption comes from the radio access network. Therefore, how to reduce the energy consumption of the radio access network is an urgent technical problem to be solved.

### SUMMARY

Embodiments of the present disclosure provide a method for configuring or reconfiguring a primary cell, a terminal, and a network device.

According to some embodiments of the present disclosure, a method for configuring or reconfiguring a primary cell is provided. The method is applicable to a terminal, and the method includes: receiving a first message; and configuring or reconfiguring the primary cell of the terminal from a first cell to a second cell based on the first message.

According to some embodiments of the present disclosure, a method for configuring or reconfiguring a primary cell is provided. The method is applicable to a network device, and the method includes: sending a first message, where the first message indicates that a primary cell of a terminal is configured or reconfigured from a first cell to a second cell.

According to some embodiments of the present disclosure, a terminal is provided. The terminal includes: a processor; a transceiver, connected to the processor; and a memory, configured to store one or more executable instructions of the processor, where the processor, when loading and executing the one or more executable instructions, is caused to perform the method for configuring or reconfiguring the primary cell as described above.

According to some embodiments of the present disclosure, a network device is provided. The network device includes: a processor; a transceiver, connected to the processor; and a memory, configured to store one or more executable instructions of the processor, where the processor, when loading and executing the one or more executable instructions, is caused to perform the method for configuring or reconfiguring a primary cell as described above.

### BRIEF DESCRIPTION OF THE DRAWINGS

To describe the technical solutions in embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 shows a schematic diagram of the architecture of a communication system according to some schematic embodiments of the present disclosure;

FIG. 2 shows a schematic diagram of the architecture of another communication system according to some schematic embodiments of the present disclosure;

FIG. 3 shows a schematic diagram of the architecture of another communication system according to some schematic embodiments of the present disclosure;

FIG. 4 shows a time-frequency schematic diagram of network energy-saving technology in the related art;

FIG. 5 shows a flowchart of a method for configuring or reconfiguring a primary cell according to some schematic embodiments of the present disclosure;

FIG. 6 shows a flowchart of a method for configuring or reconfiguring a primary cell according to some schematic embodiments of the present disclosure;

FIG. 7 shows a flowchart of a method for configuring or reconfiguring a primary cell according to some schematic embodiments of the present disclosure;

FIG. 8 shows a schematic diagram of a method for configuring or reconfiguring a primary cell according to some schematic embodiments of the present disclosure;

FIG. 9 shows a schematic diagram of a method for configuring or reconfiguring a primary cell according to some schematic embodiments of the present disclosure;

FIG. 10 shows a schematic diagram of a method for configuring or reconfiguring a primary cell according to some schematic embodiments of the present disclosure;

FIG. 11 shows a structural block diagram of an apparatus for configuring or reconfiguring a primary cell according to some schematic embodiments of the present disclosure;

FIG. 12 shows a structural block diagram of an apparatus for configuring or reconfiguring a primary cell according to some schematic embodiments of the present disclosure; and

FIG. 13 shows a structural block schematic diagram of a communication device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. Reference is made in detail to the exemplary embodiments, examples of which are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms in the present disclosure are used for describing particular embodiments only and are not intended to be limiting to the present disclosure. As used in the present disclosure and the appended claims, the singular forms “a”, “an”, and “the” are intended to include the plural forms as well, unless the context clearly indicates otherwise. It should also be understood that the term “and/or” as used herein refers to and encompasses any or all possible combinations of one or more associated listed items.

It should be understood that although the terms “first”, “second”, “third”, etc. may be used herein to describe various information, such information should not be limited to these terms. These terms are only used to distinguish one type of information from another. For example, first information is also referred to as second information, and similarly, second information is also referred to as first information, without departing from the scope of the present disclosure. The word “if”, as used herein, is interpreted as “in the case that”, “in the case of”, or “in response to a determination”, depending on the context.

First, the related technical background involved in the embodiments of the present disclosure is described as follows.

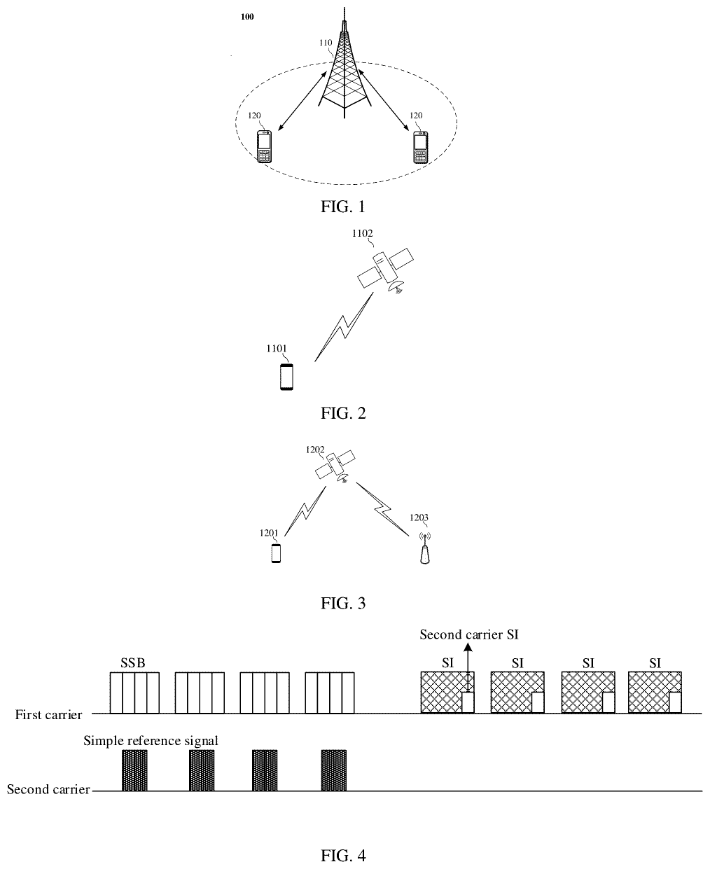

Introduction to the network scenario: The communication system scenario includes the terrestrial network (TN) and the non-terrestrial network (NTN). The NTN generally provides communication services to ground users through satellite communication. The NTN system currently includes new radio-NTN (NR-NTN) and Internet of Things-NTN (IoT-NTN) systems. Exemplarily, FIG. 1 is a schematic diagram of the architecture of a communication system according to some embodiments of the present disclosure. As shown in FIG. 1, a communication system 100 includes a network device 110, and the network device 110 is a device communicating with terminals 120 (or referred to as communication terminals, or terminal devices). The network device 110 provides communication coverage for a particular geographic region and communicates with terminal devices located within the coverage region. The network device 110 provides wireless communication services to the terminals 120 over one or more cells, such as providing services to the terminals 120 over a plurality of cells simultaneously. In the case that the network device 110 provides services to the terminals 120 over a plurality of cells, the plurality of cells perform network deployment over a carrier aggregation (CA) or dual connectivity (DC) method. Accordingly, the terminal 120 uses the services provided by the network device 110 over some (e.g., one) or all cells of the plurality of cells. In a network scenario of CA deployment, one cell of the plurality of cells is a primary cell (PCell), and the other cells are secondary cells (SCells). In the network scenario of DC deployment, the plurality of cells are divided into two cell groups, namely a master cell group (MCG) and a secondary cell group (SCG), where one cell in the MCG is a primary cell (PCell), and the other cells are secondary cells (SCells); one cell in the SCG is a primary SCG cell (PSCell), and the other cells are secondary cells (SCells). The carrier aggregation technology or the dual connectivity technology improves the throughput of the terminal 120. In the case that the terminal 120 does not support CA or DC, or the terminal 120 supports the CA or the DC but does not enable the CA or the DC, the terminal 120 uses only one cell as a primary cell or serving cell. FIG. 1 exemplarily shows one network device and two terminals, and in some embodiments of the present disclosure, the communication system 100 includes a plurality of network devices and the coverage area of each of the network devices includes other numbers of terminals, which is not limited in the embodiments of the present disclosure. The network device is a base station. Exemplarily, FIG. 2 is a schematic diagram of the architecture of another communication system according to some embodiments of the present disclosure. Referring to FIG. 2, the communication system includes a terminal 1101 and a satellite 1102, and the terminal 1101 wirelessly communicates with the satellite 1102. The network formed between the terminal 1101 and the satellite 1102 is also referred to as an NTN. In the architecture of the communication system shown in FIG. 2, the satellite 1102 functions as a base station, and the terminal 1101 communicates directly with the satellite 1102. Under the system architecture, the satellite 1102 is referred to as a network device. In some embodiments of the present disclosure, the communication system includes a plurality of network devices 1102, and the coverage area of each of the network devices 1102 includes other numbers of terminals, which is not limited in the embodiments of the present disclosure. Exemplarily, FIG. 3 is a schematic diagram of the architecture of another communication system according to some embodiments of the present disclosure. Referring to FIG. 3, the communication system includes a terminal 1201, a satellite 1202, and a base station 1203, the terminal 1201 wirelessly communicates with the satellite 1202, and communications are performed between the satellite 1202 and the base station 1203. The network formed between the terminal 1201, the satellite 1202, and the base station 1203 is also referred to as an NTN. In the architecture of the communication system shown in FIG. 3, the satellite 1202 does not function as a base station, and communications between the terminal 1201 and the base station 1203 need to be relayed over the satellite 1202. Under the system architecture, the base station 1203 is referred to as a network device. In some embodiments of the present disclosure, the communication system includes a plurality of network devices 1203, and the coverage area of each of the network devices 1203 includes other numbers of terminals, which is not limited in the embodiments of the present disclosure.

Introduction to network energy saving: Network energy saving is of great significance to environmental sustainability, environmental impact reduction (greenhouse gas emission reduction), and operational expenditure saving. With the gradual popularization of the 5^{th} generation (5G) mobile communication network in various industries and geographic regions, it is necessary to support very high data transmission rates to handle more advanced services and applications. As a result, the network deployment becomes denser and uses more antennas, larger bandwidths, and more frequency bands. Given the impact of 5G on the environment, controlled and new solutions need to be developed to enhance network energy saving. Most energy consumption comes from the radio access network. More specifically, most energy consumption comes from an active antenna unit (AAU), where the data center and the fiber optic transmission account for a smaller share. The power consumption of a single radio access is divided into two parts. The dynamic part includes only power consumption when data is being transmitted or received; the static part includes power consumption at all times to maintain the necessary operation of the radio access device, including power consumption when no data is being transmitted or received.

Therefore, based on the above, research and development of a network energy consumption model, a key performance indicator (KPI), an evaluation method, and the like on the network device side are required to determine and study a network energy-saving technology in a target deployment scenario. The defined power consumption model on the terminal side can be taken as a reference. The research should focus on how to achieve more efficient dynamic operation and/or semi-static operation, consider one or more network energy-saving technologies applicable to time, frequency, spatial, and power domains, and combine potential terminal feedback support, potential terminal auxiliary information, and information exchange or coordination between network interfaces to achieve data transmission and/or reception adaptation with finer granularity. Notably, the research not only evaluates potential network energy-saving gains, but also needs to evaluate and balance the impact on network and user performance by observing KPIs, such as spectral efficiency, capability, user perceived throughput (UPT), delay, terminal power consumption (UE power consumption), complexity, handover performance, call drop rate (CDR), initial access performance, and service level agreement (SLA) security-related KPIs. The research should avoid a large impact on the above KPIs.

A network energy-saving technology method in the related art is to increase transmission periods of the synchronization signal and PBCH block (SSB) and the system information block (SIB) 1 in the case that the network is in an idle state. However, this method increases the initial access delay of the terminal device. Therefore, for a terminal, it may not correctly identify the cell in a long SSB transmission period, and thus cannot access the network. For some scenarios, in the case that the terminal is already capable of receiving the SSB and the SIB1 over the first carrier, the common signal transmitted on the second carrier is simplified and/or is assisted in reception over signals transmitted on the first carrier. As shown in FIG. 4, the SSB transmitted on the first carrier occupies 4 symbols, and the SIB1 on the first carrier carries the scheduling information of the system information of the second carrier. In this case, the common signal (the simple reference signal in the figure) transmitted on the second carrier (i.e., other carriers) only occupies 2 symbols, and compared with 4 symbols occupied by the SSB on the first carrier, the number of symbols occupied by the common signal on the second carrier is smaller. Meanwhile, the common signal reduces the impact on the synchronization precision performance and access delay of the terminal. However, the technical solutions in the related art have the following disadvantages: the common signal transmitted on the second carrier needs to be redesigned; since the number of symbols occupied by the new common signal is small, in addition to the need to evaluate the gain of the new common signal to the network energy saving and evaluate the impact of the new common signal on the terminal performance, additional terminal implementation complexity also needs to be considered. Therefore, the present disclosure mainly considers how to save network energy without introducing a new common signal design.

It should be understood that in some embodiments of the present disclosure, cells and carriers are equivalent. For example, “first cell” is replaced with “first carrier”, “second cell” is replaced with “second carrier”, and so on.

It should be understood that in some embodiments of the present disclosure, a “5G NR system” is also referred to as a 5G system or a new radio (NR) system. The technical solutions described in some embodiments of the present disclosure are applicable to 5G NR systems, subsequent evolution systems of the 5G NR systems, or 6G and subsequent evolution systems.

A method for configuring or reconfiguring a primary cell is provided according to the embodiments of the present disclosure. According to the method, in the case that two or more cells are deployed in a network device, if the traffic load in the network device is low or the number of terminals served by the network device in the current time period is small, the network device concentrates the terminals it serves into one cell or part of the cells, for example, a second cell, among the two or more cells; for the first cell where the terminal is transferred, the network device turns off the first cell or only transmits a basic common signal over the first cell to maintain the initial access, paging, and other functions of the terminal, thereby saving energy consumption of the network device. In some embodiments, for a network device set up at a tourist attraction, because the business hours of the tourist attraction are from 8:00 to 19:00, the number of terminals served by the network device is greatly reduced during non-business hours; the network device concentrates the terminals it serves into a second cell during the non-business hours, and transmits only basic common signals over a first cell or turns off the first cell, thereby saving the energy consumption of the network during the non-business hours.

From the perspective of the terminal, in the case that the terminal accesses the network over the first cell, the first cell is the primary cell of the terminal. In the case that the network deployment includes a plurality of cells, the network device configures the second cell as a secondary cell for the terminal. Further, in the case that the network device determines to employ an energy-saving mode for the first cell (e.g., turn off the first cell or transmit only basic common signals over the first cell), the network device reconfigures the primary cell of the terminal from the first cell to the second cell.

The network device configures or reconfigures the primary cell of the terminal from the first cell to the second cell, or the terminal configures or reconfigures the primary cell from the first cell to the second cell based on the indication of the network device. In different time periods, the network device reconfigures the primary cell of the terminal from the second cell to the first cell, or the terminal reconfigures the primary cell from the second cell to the first cell based on the indication of the network device.

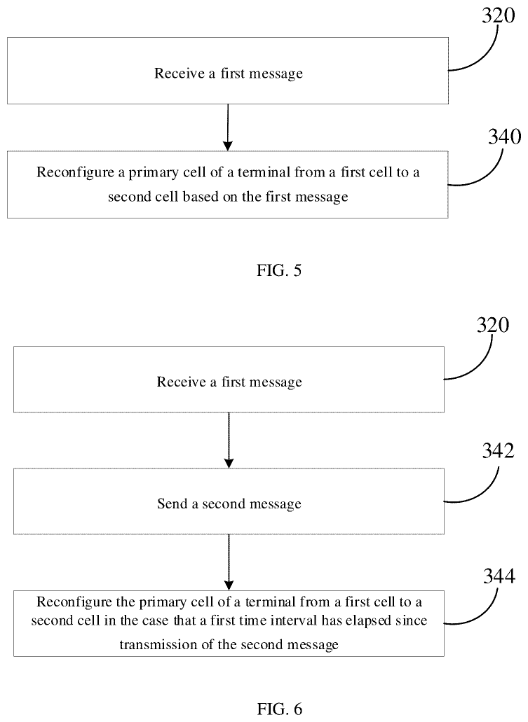

FIG. 5 shows a flowchart of a method for configuring or reconfiguring a primary cell according to some schematic embodiments of the present disclosure. The method is exemplified as being used in a terminal, and the method includes at least some of the following processes.

In process 320, a first message is received.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the terminal starts transmitting the second message or the moment when the transmission of the second message ends, where the second message is sent after the terminal receives the first message, and is configured to confirm that the first message has been received.

In some embodiments, the terminal has the CA or DC capability. The first cell is the primary cell of the terminal, the second cell is the secondary cell of the terminal, and the two cells both serve as the serving cell for the terminal.

In some embodiments, the terminal does not have the CA or DC capability, or the terminal has the CA or DC capability but does not enable CA or DC. The first cell is the primary cell or the serving cell of the terminal. The second cell is a neighbor cell of the terminal.

In some embodiments, the first message indicates that the terminal reconfigures the primary cell from the first cell to the second cell; or, the first message indicates that the terminal no longer configures the first cell as the primary cell; or, the first message indicates that the terminal configures the second cell as the primary cell.

In some embodiments, the first message indicates that the terminal reconfigures the serving cell from the first cell to the second cell; or, the first message indicates that the terminal no longer configures the first cell as the serving cell; or, the first message indicates that the terminal configures the second cell as the serving cell.

In some embodiments, the first message includes at least one of the following:
indication information indicating that the first cell is no longer configured as the primary cell or the serving cell;
indication information indicating that the second cell is configured as the primary cell or the serving cell;
indication information for initiating the reconfiguration of the primary cell or the serving cell;
configuration information of the second cell (e.g. a new primary cell or a new serving cell);
indication information indicating that the first cell is configured as a dormant cell;
indication information of the feedback resource corresponding to the first message; and
indication information of a first time interval, configured to determine the first time interval.

In some embodiments, the relationship between the coverage areas of the first cell and the second cell is at least one of the following:
the coverage areas of the first cell and the second cell being the same;
the coverage areas of the first cell and the second cell being different;
the coverage area of the first cell being greater than the coverage area of the second cell; and
the coverage area of the first cell being smaller than the coverage area of the second cell. In some embodiments, the first cell and the second cell are same-frequency cells.

In some embodiments, the first cell and the second cell are different-frequency cells.

In some embodiments, the first cell and the second cell are both the serving cells of the terminal. In some embodiments, the first cell and the second cell are different-frequency cells, or the first cell and the second cell are same-frequency cells.

In some embodiments, the first cell is the serving cell of the terminal and the second cell is not the serving cell of the terminal. In some embodiments, the first cell and the second cell are different-frequency cells, or the first cell and the second cell are same-frequency cells.

In some embodiments, the first cell and the second cell are provided by the same network device, or the first cell and the second cell are provided by different network devices.

In some embodiments, the first message is a broadcast message, a multicast message, or UE-specific signaling.

In process 340, the primary cell or the serving cell of the terminal is configured or reconfigured from the first cell to the second cell based on the first message.

In some embodiments, “configuration” is considered as the network device configuring the primary cell for the terminal for the first time, or configuring the primary cell for the terminal in the case that the terminal has not yet been configured with a primary cell.

In some embodiments, “configuration” is considered as the network device configuring the serving cell for the terminal for the first time, or configuring the serving cell for the terminal in the case that the terminal has not yet been configured with a serving cell.

In some embodiments, “reconfiguration” is considered as the network device configuring the primary cell for the terminal not for the first time, or configuring the primary cell for the terminal again in the case that the terminal has already been configured with a primary cell.

In some embodiments, “reconfiguration” is considered as the network device configuring the serving cell for the terminal not for the first time, or configuring the serving cell for the terminal again in the case that the terminal has already been configured with a serving cell.

In some embodiments, “reconfiguration” is also referred to simply as “configuration”.

In some embodiments, the first cell and the second cell are both the serving cells of the terminal. After receiving the first message, the terminal reconfigures the primary cell of the terminal from the first cell to the second cell, or the terminal no longer configures the first cell as the primary cell; and/or the terminal configures the second cell as the primary cell.

In some embodiments, the first cell is the serving cell of the terminal and the second cell is not the serving cell of the terminal. After receiving the first message, the terminal reconfigures the serving cell of the terminal from the first cell to the second cell, or the terminal no longer configures the first cell as the serving cell; and/or the terminal configures the second cell as the serving cell.

In summary, according to the method provided in the embodiments, in the case that the first cell is determined to use the energy-saving mode, the primary cell of the terminal is configured or reconfigured from the first cell to the second cell, thereby saving the network energy without introducing any additional common signal design.

In some embodiments, the above process 340 is implemented as process 342 and/or process 344, as shown in FIG. 6.

In process 342: a second message is sent.

The second message is sent after the terminal receives the first message, and is configured to confirm that the first message has been received. The second message is feedback information corresponding to the first message.

In process 344, in the case that the first time interval has elapsed since the transmission of the second message, the primary cell or the serving cell of the terminal is configured or reconfigured from the first cell to the second cell.

The starting point of the first time interval is the moment when the terminal transmits the second message or the moment when the transmission of the second message ends.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.

In some embodiments, after the first time interval, the primary cell of the terminal is configured or reconfigured from the first cell to the second cell, or the terminal no longer configures the first cell as the primary cell; and/or the terminal configures the second cell as the primary cell.

In some embodiments, after the first time interval, the serving cell of the terminal is reconfigured from the first cell to the second cell, or the terminal no longer configures the first cell as the serving cell; and/or the terminal configures the second cell as the serving cell.

In some embodiments, for example in a DC network deployment scenario, the primary cell includes the PCell in the MCG, and/or the PSCell in the SCG.

In summary, according to the method provided in the embodiments, the primary cell or the serving cell of the terminal is reconfigured from the first cell to the second cell based on the first message, where the first cell is the cell that is determined to employ the energy-saving mechanism, or the cell that is about to employ the energy-saving mechanism, or the cell that employs the energy-saving mechanism after the time interval x, x being configured or predefined by the network device. In this case, in the NR system and the evolution system thereof, the network energy is saved without introducing additional common signal design.

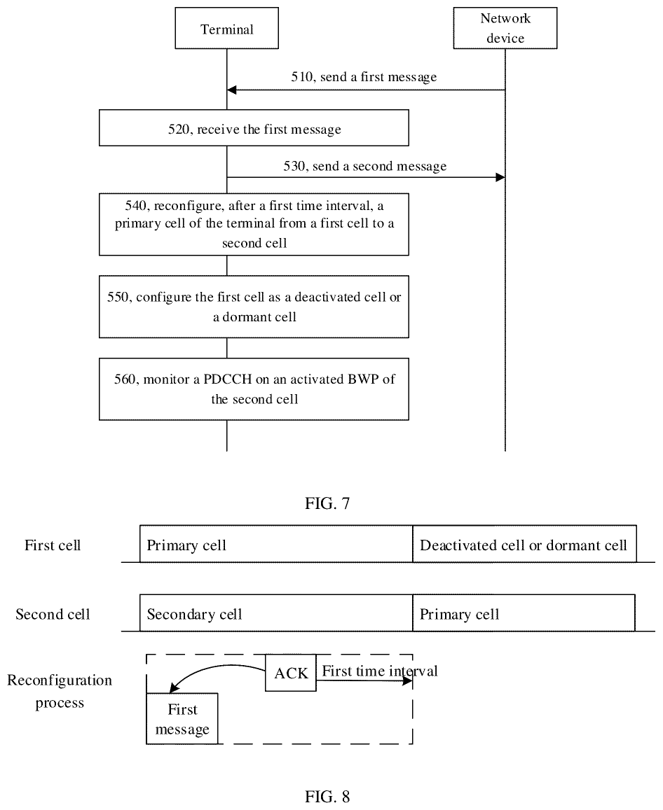

FIG. 7 shows a schematic diagram of a method for configuring or reconfiguring a primary cell according to some other exemplary embodiments of the present disclosure. The method includes at least some of the following processes:

In process 510, a network device sends a first message to a terminal.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the terminal starts transmitting the second message or the moment when the transmission of the second message ends, where the second message is sent after the terminal receives the first message, and is configured to confirm that the first message has been received.

In some embodiments, the terminal has the CA or DC capability. The first cell is the primary cell of the terminal, the second cell is the secondary cell of the terminal, and the two cells both serve as the serving cell for the terminal.

In some embodiments, the terminal does not have the CA or DC capability, or the terminal has the CA or DC capability but does not enable CA or DC. The first cell is the primary cell or the serving cell of the terminal. The second cell is a neighbor cell of the terminal.

In some embodiments, the first message indicates that the terminal configures or reconfigures the primary cell from the first cell to the second cell; or, the first message indicates that the terminal no longer configures the first cell as the primary cell; or, the first message indicates that the terminal configures the second cell as the primary cell.

In some embodiments, the first message indicates that the terminal configures or reconfigures the serving cell from the first cell to the second cell; or, the first message indicates that the terminal no longer configures the first cell as the serving cell; or, the first message indicates that the terminal configures the second cell as the serving cell.

In some embodiments, the first message includes at least one of the following:
indication information indicating that the first cell is no longer configured as the primary cell or the serving cell;
indication information indicating that the second cell is configured as the primary cell or the serving cell;
indication information for initiating reconfiguration of the primary cell or the serving cell;
configuration information of the second cell (e.g. a new primary cell or a new serving cell);
indication information indicating that the first cell is configured as a dormant cell;
indication information of the feedback resource corresponding to the first message; and
indication information of a first time interval, configured to determine the first time interval.

In some embodiments, the first cell and the second cell are same-frequency cells.

In some embodiments, the first cell and the second cell are different-frequency cells.

In some embodiments, the first cell and the second cell are both the serving cells of the terminal. In some embodiments, the first cell and the second cell are different-frequency cells, or the first cell and the second cell are same-frequency cells.

In some embodiments, the first cell is the serving cell of the terminal and the second cell is not the serving cell of the terminal. In some embodiments, the first cell and the second cell are different-frequency cells, or the first cell and the second cell are same-frequency cells.

In some embodiments, the first cell and the second cell are provided by the same network device, or the first cell and the second cell are provided by different network devices.

In some embodiments, the first message is a system message; or, the first message is a medium access control (MAC) control element (CE) message; or, the first message is a radio resource control (RRC) message; or, the first message is a downlink control information (DCI) message.

In some embodiments, the first cell and the second cell are both downlink cells, and the first message is transmitted over the first cell; or, the first message is transmitted over the second cell; or, the first message is transmitted over a third cell, and the third cell is a downlink cell except the first cell and the second cell. Exemplarily, the network device transmits the first message over the first cell, the second cell, or the third cell, and accordingly, the terminal receives the first message sent by the network device over the first cell, the second cell, or the third cell.

In some embodiments, the first message being transmitted over the first cell, includes: the first message being transmitted through spectrum resources in the first cell. Alternatively, the first message being transmitted over the second cell, includes: the first message being transmitted through spectrum resources in the second cell. Alternatively, the first message being transmitted over the third cell, includes: the first message being transmitted through spectrum resources in the third cell.

In some embodiments, the first message is a broadcast message, a multicast message, or UE-specific signaling.

In process 520, the terminal receives the first message sent by the network device.

In process 530, the terminal transmits a second message.

After receiving the first message, the terminal transmits the second message (or referred to as a first confirmation command) to the network device to confirm that the first message has been received.

In some embodiments, the second message includes the acknowledgment (ACK) information.

In some embodiments, the second message includes the ACK information or the negative acknowledgment (NACK) information.

In some embodiments, the second message is uplink control information (UCI), where the second message is transmitted through a physical uplink control channel (PUCCH), or the second message is transmitted through a physical uplink shared channel (PUSCH), for example, the second message is transmitted in the form that the UCI is multiplexed to the PUSCH. In some embodiments, the PUSCH is a DCI-scheduled PUSCH or a configured grant-PUSCH (CG-PUSCH).

In some embodiments, the second message is a MAC CE or RRC message. In some embodiments, the second message is transmitted through a PUSCH. In some embodiments, the PUSCH is a DCI-scheduled PUSCH or a CG-PUSCH.

In some embodiments, the first cell and the second cell are both uplink cells, and the second message is transmitted over the first cell; or, the second message is transmitted over the second cell; or, the second message is transmitted over a fourth cell, and the fourth cell is an uplink cell except the first cell and the second cell. Exemplarily, the terminal transmits the second message over the first cell, the second cell, or the fourth cell, and accordingly, the network device receives the second message sent by the terminal over the first cell, the second cell, or the fourth cell.

In some embodiments, the second message being transmitted over the first cell, includes: the second message being transmitted through spectrum resources in the first cell. Alternatively, the second message being transmitted over the second cell, includes: the second message being transmitted through spectrum resources in the second cell. Alternatively, the second message being transmitted over the fourth cell, includes: the second message being transmitted through spectrum resources in the fourth cell.

In process 540, after the first time interval, the terminal configures or reconfigures the primary cell from the first cell to the second cell, or the terminal no longer configures the first cell as the primary cell, or the terminal configures the second cell as the primary cell; or, after the first time interval, the terminal configures or reconfigures the serving cell from the first cell to the second cell, or the terminal no longer configures the first cell as the serving cell, or the terminal configures the second cell as the serving cell.

The starting point of the first time interval is the moment when the terminal starts transmitting the second message or the moment when the transmission of the second message ends, where the second message is transmitted after the terminal receives the first message, and is configured to confirm that the first message has been received.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.

In some embodiments, the first cell and the second cell are both the serving cells of the terminal. After the first time interval, the terminal reconfigures the primary cell from the first cell to the second cell, or the terminal no longer configures the first cell as the primary cell; and/or the terminal configures the second cell as the primary cell.

In some embodiments, the first cell is the serving cell of the terminal and the second cell is not the serving cell of the terminal. After the first time interval, the terminal reconfigures the serving cell from the first cell to the second cell, or the terminal no longer configures the first cell as the serving cell; and/or the terminal configures the second cell as the serving cell.

In some embodiments, for example in the DC network deployment scenario, the primary cell includes the PCell in the MCG, and/or the PSCell in the SCG.

In process 550, the terminal deactivates the first cell, or the terminal configures the first cell as a dormant cell.

In some embodiments, the network device configures the first cell as a deactivated cell or as a dormant cell (dormancy).

In process 560, the terminal monitors a physical downlink control channel (PDCCH) on an active bandwidth part (BWP) of the second cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the reconfiguration process, the network device and the terminal both reserve some contexts, such as the cell-radio-network temporary identifier (C-RNTI) of the first cell, such that the terminal still considers the first cell as the primary cell in the case of a configuration or reconfiguration failure.

For process 510, in the case that the first message carries the configuration information of the second cell, the configuration information of the second cell includes at least one of the following:
a cell identity (ID) of the second cell and/or a cell index of the second cell;
a synchronization signal/PBCH block (SSB) index and/or a candidate SSB index of the second cell;
a master information block (MIB) and/or SIB1 of the second cell;
other system message configurations of the second cell,
where the other system messages refer to SIBs in addition to MIB and SIB1, such as SIB2 and SIB3;
a BWP configuration of the second cell;
a subcarrier spacing configuration of the second cell;
a control-resource set (CORESET) configuration of the second cell;
a search space set (SSS) configuration of the second cell;
a PDCCH configuration of the second cell;
a pre-authorized resource configuration (configured grant config) of the second cell;
a first RNTI of the second cell;
timing adjustment indication information of the second cell; and
uplink transmission waveform information of the second cell.

In some embodiments of the present disclosure, the second cell includes a downlink cell and/or an uplink cell. Alternatively, the primary cell reconfigured by the network device includes a downlink cell and/or an uplink cell.

In some embodiments of the present disclosure, the BWP configuration of the second cell is configured to determine at least one of the following information: a downlink BWP configuration, an uplink BWP configuration, a downlink BWP ID, and an uplink BWP ID of the second cell. In some embodiments, the downlink BWP includes a downlink activated BWP and/or a downlink configured BWP. In some embodiments, the uplink BWP includes an uplink activated BWP and/or an uplink configured BWP. For example, the BWP configuration information includes the ID of the downlink activated BWP and the configuration of the downlink activated BWP, where the downlink activated BWP configuration includes the indication of the starting position and the length of the BWP, and the terminal determines the ID of the downlink activated BWP and the bandwidth of the downlink activated BWP based on the BWP configuration information.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the terminal monitors the PDCCH on the second cell and/or receives downlink transmission on the first cell based on the downlink subcarrier spacing determined by the subcarrier spacing configuration. For another example, the terminal transmits the PUSCH and/or PUCCH and/or semi-persistent scheduling (SRS) based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the terminal monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the resource block (RB) occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., transmission configuration indicator (TCI) information, and/or quasi-co-location (QCL) reference signal information, and/or quasi-co-location type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the demodulation reference signal (DMRS) parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink hybrid automatic repeat request (HARQ) process number, the period of the pre-authorized resource, the number of repetitions using the pre-authorized resource for transmission, the corresponding redundancy version (RV) of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the modulation and coding scheme (MCS) and transport block size (TBS) indication, the SRS resource indication, the frequency domain hopping offset indication, and the path loss reference indication.

It should be understood that in the embodiments of the present disclosure, time units of the second cell may be an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a configured scheduling RNTI (CS-RNTI) of the second cell.

In some embodiments of the present disclosure, the timing adjustment indication information of the second cell is a time advance (TA) command.

In some embodiments of the present disclosure, the uplink transmission waveform information of the second cell is configured to determine whether a discrete Fourier transform (DFT) precoder is used (or whether the waveform used is an orthogonal frequency division multiplexing (OFDM) waveform or a DFT-S-OFDM waveform) when the terminal device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-spread OFDM (DFT-S-OFDM) waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

For the embodiments in which the first cell is the primary cell and the second cell is the secondary cell.

FIG. 8 shows a time-frequency schematic diagram of a method for configuring or reconfiguring a primary cell according to some exemplary embodiments of the present disclosure. The method includes at least some of the following processes:
A network device sends a first message to a terminal.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the terminal starts transmitting the second message or the moment when the transmission of the second message ends, where the second message is sent after the terminal receives the first message, and is configured to confirm that the first message has been received.

The first message indicates that the terminal configures or reconfigures the primary cell from the first cell to the second cell; or, the first message indicates that the terminal no longer configures the first cell as the primary cell; or, the first message indicates that the terminal configures the second cell as the primary cell.

In some embodiments, the first message includes at least one of the following:
indication information indicating that the first cell is no longer configured as the primary cell;
indication information indicating that the second cell is configured as the primary cell;
indication information for initiating the reconfiguration of the primary cell;
configuration information of the second cell (namely, the primary cell);
indication information indicating that the first cell is configured as a dormant cell;
indication information of the feedback resource corresponding to the first message; and
indication information of a first time interval, configured to determine the first time interval.

In the case that the first message carries the configuration information of the second cell, the configuration information of the second cell includes at least one of the following: the cell ID of the second cell, the cell index of the second cell, the SSB index of the second cell, the candidate SSB index of the second cell, the MIB of the second cell, the SIB1 of the second cell, other system message configurations of the second cell, the BWP configuration of the second cell, the subcarrier spacing configuration of the second cell, the control-resource set configuration of the second cell, the search space set configuration of the second cell, the PDCCH configuration of the second cell, the pre-authorized resource configuration of the second cell, the first RNTI of the second cell, the timing adjustment indication information of the second cell, and the uplink transmission waveform information of the second cell, where the other system messages refer to SIBs in addition to MIB and SIB1, such as SIB2 and SIB3.

In some embodiments, the first message is a system message; or, the first message is a MAC CE message; or, the first message is an RRC message; or, the first message is a DCI message.

In some embodiments, the first cell and the second cell are both downlink cells, and the first message is transmitted over the first cell; or, the first message is transmitted over the second cell; or, the first message is transmitted over a third cell, and the third cell is a downlink cell except the first cell and the second cell.

In some embodiments, the first message is a broadcast message, a multicast message, or UE-specific signaling.
The terminal receives the first message sent by the network device.
After receiving the first message, the terminal transmits a second message (or referred to as a first confirmation command) to the network device to confirm that the first message has been received.

In some embodiments, the second message is ACK information.

In some embodiments, the second message includes ACK information or NACK information.

In some embodiments, the second message is UCI, where the second message is transmitted through a PUCCH, or the second message is transmitted through a PUSCH, for example, the second message is transmitted in the form that the UCI is multiplexed to the PUSCH. In some embodiments, the PUSCH is a DCI-scheduled PUSCH or a CG-PUSCH.

In some embodiments, the second message is a MAC CE or RRC message. In some embodiments, the second message is transmitted through a PUSCH. In some embodiments, the PUSCH is a DCI-scheduled PUSCH or a CG-PUSCH.

In some embodiments, the first cell and the second cell are both uplink cells, and the second message is transmitted over the first cell; or, the second message is transmitted over the second cell; or, the second message is transmitted over a fourth cell, and the fourth cell is an uplink cell except the first cell and the second cell.
In the case that the first time interval has elapsed since transmission of the first confirmation command, the terminal device configures or reconfigures the primary cell from the first cell to the second cell, or no longer configures the first cell as the primary cell, or configures the second cell as the primary cell.

The starting point of the first time interval is the moment when the terminal transmits the second message or the moment when the transmission of the second message ends. The second message is sent after the terminal receives the first message, and is configured to confirm that the first message has been received.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.
The terminal configures the first cell as a dormant cell, or the terminal deactivates the first cell.

In some embodiments, the network device configures the first cell as a deactivated cell or as a dormant cell.
The terminal monitors a PDCCH on an activated BWP of the second cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the reconfiguration process, the network device and the terminal both reserve some contexts, such as the C-RNTI of the first cell, such that the terminal still considers the first cell as the primary cell in the case of a configuration or reconfiguration failure.

In some embodiments of the present disclosure, the second cell includes a downlink cell and/or an uplink cell. Alternatively, the primary cell reconfigured by the network device includes a downlink cell and/or an uplink cell.

In some embodiments of the present disclosure, the BWP configuration of the second cell is configured to determine at least one of the following information: a downlink BWP configuration, an uplink BWP configuration, a downlink BWP ID, and an uplink BWP ID of the second cell. In some embodiments, the downlink BWP includes a downlink activated BWP and/or a downlink configured BWP. In some embodiments, the uplink BWP includes an uplink activated BWP and/or an uplink configured BWP. For example, the BWP configuration information includes the ID of the downlink activated BWP and the configuration of the downlink activated BWP, where the downlink activated BWP configuration includes the indication of the starting position and the length of the BWP, and the terminal determines the ID of the downlink activated BWP and the bandwidth of the downlink activated BWP based on the BWP configuration information.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the terminal monitors the PDCCH on the second cell and/or receives downlink transmission on the first cell based on the downlink subcarrier spacing determined by the subcarrier spacing configuration. For another example, the terminal transmits the PUSCH and/or PUCCH and/or SRS based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the terminal monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the RB occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., TCI information, and/or QCL reference signal information, and/or QCL type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the DMRS parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink HARQ process number, the period of the pre-authorized resource, the number of repetitions using the pre-authorized resource for transmission, the corresponding RV of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the MCS and TBS indication, the SRS resource indication, the frequency domain hopping offset indication, and the path loss reference indication.

It should be understood that in the embodiments of the present disclosure, time units of the second cell may be an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a CS-RNTI of the second cell.

In some embodiments of the present disclosure, the timing adjustment indication information of the second cell is a TA command.

In some embodiments of the present disclosure, the uplink transmission waveform information of the second cell is configured to determine whether a DFT precoder is used (or whether the waveform used is an OFDM waveform or a DFT-S-OFDM waveform) in the case that the terminal device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-S-OFDM waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

For the embodiments in which the first cell is a downlink primary cell, the second cell is a downlink secondary cell, and the first cell is used to receive the first message.

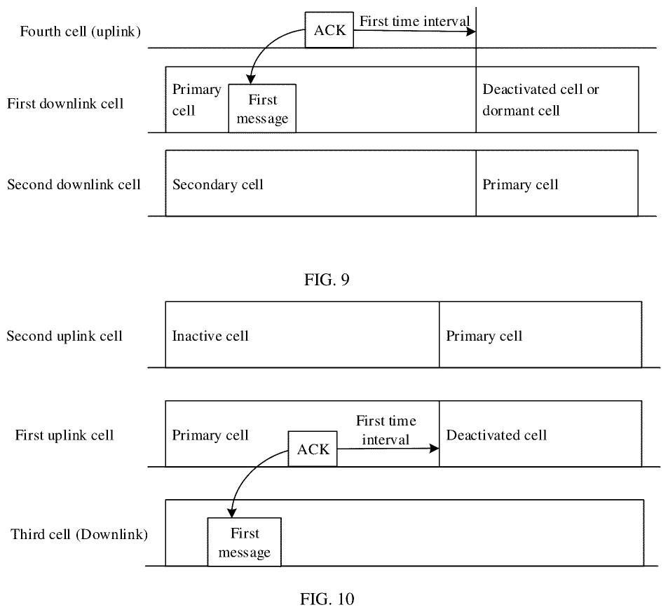

FIG. 9 shows a time-frequency schematic diagram of a method for configuring or reconfiguring a primary cell according to some exemplary embodiments of the present disclosure.

The method includes at least some of the following processes:
A network device transmits a first message to a terminal.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the terminal starts transmitting the second message or the moment when the transmission of the second message ends, where the second message is sent after the terminal receives the first message, and is configured to confirm that the first message has been received.

The first message indicates that the terminal configures or reconfigures the downlink primary cell from the first cell to the second cell; or, the first message indicates that the terminal no longer configures the first cell as the downlink primary cell; or, the first message indicates that the terminal configures the second cell as the downlink primary cell.

In some embodiments, the first message includes a reconfiguration command and/or configuration information of the second cell.

In the case that the first message carries the configuration information of the second cell, the configuration information of the second cell includes at least one of the following: the cell ID of the second cell, the cell index of the second cell, the SSB index of the second cell, the candidate SSB index of the second cell, the MIB of the second cell, the SIB1 of the second cell, other system message configurations of the second cell, the downlink BWP configuration of the second cell, the downlink subcarrier spacing configuration of the second cell, the control-resource set configuration of the second cell, the search space set configuration of the second cell, the PDCCH configuration of the second cell, and the RNTI of the second cell, where the other system messages refer to SIBs in addition to MIB and SIB1, such as SIB2 and SIB3.

In some embodiments, the first message is a system message; or, the first message is a MAC CE message; or, the first message is an RRC message; or, the first message is transmitted through a PDSCH scheduled by a first PDCCH.

In some embodiments, the first message is transmitted over the first cell (i.e., the first downlink cell).

In some embodiments, the first message is a broadcast message, a multicast message, or UE-specific signaling.
The terminal receives the first message sent by the network device.
After receiving the first message, the terminal sends a second message (or referred to as a first confirmation command) to the network device to confirm that the first message has been received.

In some embodiments, the second message is ACK information.

In some embodiments, the second message includes ACK information or NACK information.

In some embodiments, the second message is UCI, where the UCI is transmitted through a first PUCCH resource indicated by the first PDCCH; or, the second message is transmitted through a PUSCH.

In some embodiments, the second message is transmitted over a fourth cell, where the fourth cell is an uplink cell.
In the case that the first time interval has elapsed since transmission of the first confirmation command, the terminal device configures or reconfigures the downlink primary cell from the first cell to the second cell, or no longer configures the first cell as the downlink primary cell, or configures the second cell as the downlink primary cell.

The starting point of the first time interval is the moment when the terminal starts transmitting the second message or the moment when the transmission of the second message ends, where the second message is sent after the terminal receives the first message, and is configured to confirm that the first message has been received.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.
The terminal configures the first cell as a dormant cell, or the terminal deactivates the first cell.

In some embodiments, the terminal receives a dormancy indication or deactivation command from the network device, and enters dormancy or deactivates the first cell based on the dormancy indication or deactivation command; or, the first message includes a dormancy indication or deactivation command for the first cell, and the terminal enters dormancy or deactivates the first cell based on the dormancy indication or deactivation command for the first cell.
The terminal monitors a PDCCH on a downlink activated BWP of the second cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the configuration and reconfiguration process, the network device and the terminal both reserve some contexts, such as the C-RNTI of the first cell, such that the terminal still considers the first cell as the primary cell in the case of a configuration or reconfiguration failure.

In some embodiments of the present disclosure, the BWP configuration of the second cell is configured to determine at least one of the following information: a downlink BWP configuration, an uplink BWP configuration, a downlink BWP ID, and an uplink BWP ID of the second cell. In some embodiments, the downlink BWP includes a downlink activated BWP and/or a downlink configured BWP. In some embodiments, the uplink BWP includes an uplink activated BWP and/or an uplink configured BWP. For example, the BWP configuration information includes the ID of the downlink activated BWP and the configuration of the downlink activated BWP, where the downlink activated BWP configuration includes the indication of the starting position and the length of the BWP, and the terminal determines the ID of the downlink activated BWP and the bandwidth of the downlink activated BWP based on the BWP configuration information.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the terminal monitors the PDCCH on the second cell and/or receives downlink transmission on the first cell based on the downlink subcarrier spacing determined by the subcarrier spacing configuration. For another example, the terminal transmits the PUSCH and/or PUCCH and/or SRS based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the terminal monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the RB occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., TCI information, and/or QCL reference signal information, and/or QCL type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the DMRS parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink HARQ process number, the period of the pre-authorized resource, the number of repetitions using the pre-authorized resource for transmission, the corresponding RV of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the MCS and TBS indication, the SRS resource indication, the frequency domain hopping offset indication, and the path loss reference indication.

It should be understood that in the embodiments of the present disclosure, time units of the second cell may be an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a CS-RNTI of the second cell.

In some embodiments of the present disclosure, the timing adjustment indication information of the second cell is a TA command.

In some embodiments of the present disclosure, the uplink transmission waveform information of the second cell is configured to determine whether a DFT precoder is used (or whether the waveform used is an OFDM waveform or a DFT-S-OFDM waveform) in the case that the terminal device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-S-OFDM waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

For the embodiments in which the first cell is an uplink primary cell, the second cell is an inactive uplink cell, and the third cell is used to receive the first message.

FIG. 10 shows a schematic diagram of a method for configuring or reconfiguring a primary cell according to some exemplary embodiments of the present disclosure. The method includes at least some of the following processes:
A network device transmits a first message to a terminal.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the terminal starts transmitting the second message or the moment when the transmission of the second message ends, where the second message is sent after the terminal receives the first message, and is configured to confirm that the first message has been received.

The first message indicates that the terminal configures or reconfigures the uplink primary cell from the first cell to the second cell; or, the first message indicates that the terminal no longer configures the first cell as the uplink primary cell; or, the first message indicates that the terminal configures the second cell as the uplink primary cell.

In some embodiments, the first message includes a reconfiguration command and/or configuration information of the second cell.

In the case that the first message carries the configuration information of the second cell, the configuration information of the second cell includes at least one of the following: the cell ID of the second cell, the cell index of the second cell, the uplink activated BWP configuration of the second cell, the uplink subcarrier spacing configuration of the second cell, the pre-authorized resource configuration of the second cell, the timing adjustment indication information of the second cell, the uplink transmission waveform information of the second cell, and the C-RNTI of the second cell.

In some embodiments, the first message is a system message; or, the first message is a MAC CE or RRC message; or, the first message is transmitted through a PDSCH scheduled by a first PDCCH.

In some embodiments, the first message is transmitted over a third cell, where the third cell is a downlink cell.

In some embodiments, the first message is a broadcast message, a multicast message, or UE-specific signaling.
The terminal receives the first message sent by the network device.
After receiving the first message, the terminal transmits a second message (or referred to as a first confirmation command) to the network device to confirm that the first message has been received.

In some embodiments, the second message is ACK information.

In some embodiments, the second message includes ACK information or NACK information.

In some embodiments, the second message is UCI, where the UCI is transmitted through a first PUCCH resource indicated by the first PDCCH; or, the second message is transmitted through a PUSCH.

In some embodiments, the second message is transmitted through the resources on the first cell; in some embodiments, the second cell is a configured but inactive cell; or, the second message is transmitted through the resources on the second cell; in some embodiments, the second cell is an active cell.
In the case that the first time interval has elapsed since transmission of the second message, the terminal configures or reconfigures the uplink primary cell from the first cell to the second cell.

The starting point of the first time interval is the moment when the terminal transmits the second message or the moment when the transmission of the second message ends, where the second message is sent after the terminal receives the first message, and is configured to confirm that the first message has been received.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.

In some embodiments, the second message is transmitted through the resources on the first cell, and the value of the first time interval is not 0; or, the first confirmation command is transmitted through the resources on the second cell, and the value of the first time interval is 0.
The terminal deactivates the first cell.

In some embodiments, the terminal receives a deactivation command from the network device, and deactivates the first cell based on the deactivation command; or, the first message includes a deactivation command for the first cell, and the terminal device deactivates the first cell based on the deactivation command for the first cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the reconfiguration process, the network device and the terminal both reserve some contexts, such as the C-RNTI of the first cell, such that the terminal still considers the first cell as the primary cell in the case of a configuration or reconfiguration failure.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the terminal monitors the PDCCH on the second cell and/or receives downlink transmission on the first cell based on the downlink subcarrier spacing determined by the subcarrier spacing configuration. For another example, the terminal transmits the PUSCH and/or PUCCH and/or SRS based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the terminal monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the RB occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., TCI information, and/or QCL reference signal information, and/or QCL type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the DMRS parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink HARQ process number, the period of the pre-authorized resource, the number of repetitions using the pre-authorized resource for transmission, the corresponding RV of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the MCS and TBS indication, the SRS resource indication, the frequency domain hopping offset indication, and the path loss reference indication.

It should be understood that in the embodiments of the present disclosure, time units of the second cell may be an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a CS-RNTI of the second cell.

In some embodiments of the present disclosure, the timing adjustment indication information of the second cell is a TA command.

In some embodiments of the present disclosure, the uplink transmission waveform information of the second cell is configured to determine whether a DFT precoder is used (or whether the waveform used is an OFDM waveform or a DFT-S-OFDM waveform) in the case that the terminal device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-S-OFDM waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

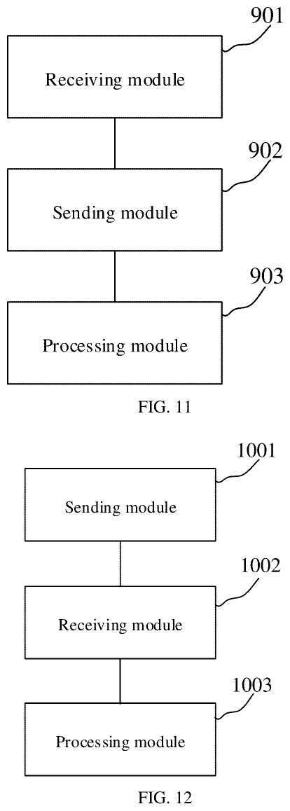

FIG. 11 shows a structural block diagram of an apparatus for configuring or reconfiguring a primary cell according to some schematic embodiments of the present disclosure. The apparatus includes the following modules.

A receiving module 901 is configured to receive a first message.

The first message is sent by the network device for energy savings. The first message is sent in the case that the network device determines to employ the energy-saving mode for the first cell. In some embodiments, the first message is sent in the case that the network device determines to turn off the first cell, or the first message is sent in the case that the network device determines to configure the first cell as an inactive cell, or the first message is sent in the case that the network device determines to configure the first cell as a dormant cell, or the first message is sent in the case that the network device determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the network device. The starting point of the time interval is the moment when the apparatus starts transmitting the second message or the moment when the transmission of the second message ends, where the second message is sent after the apparatus receives the first message, and is configured to confirm that the first message has been received.

In some embodiments, the first message indicates that a processing module 903 configures or reconfigures the primary cell of the apparatus from the first cell to the second cell; or, the first message indicates that the processing module 903 no longer configures the first cell of the apparatus as the primary cell; or, the first message indicates that the processing module 903 configures the second cell of the apparatus as the primary cell.

In some embodiments, the first message indicates that the processing module 903 configures or reconfigures the serving cell of the apparatus from the first cell to the second cell; or, the first message indicates that the processing module 903 no longer configures the first cell of the apparatus as the serving cell; or, the first message indicates that the processing module 903 configures the second cell of the apparatus as the serving cell.

In some embodiments, the apparatus has the CA or DC capability. The first cell is the primary cell of the apparatus, the second cell is the secondary cell of the apparatus, and the two cells both serve as the serving cell of the apparatus.

In some embodiments, the apparatus does not have the CA or DC capability, or the apparatus has the CA or DC capability but does not enable CA or DC. The first cell is the primary cell or the serving cell of the apparatus. The second cell is a neighbor cell of the apparatus.

In some embodiments, the first message includes at least one of the following:
indication information indicating that the first cell is no longer configured as the primary cell or the serving cell;
indication information indicating that the second cell is configured as the primary cell or the serving cell;
indication information for initiating the reconfiguration of the primary cell or the serving cell;
configuration information of the second cell (e.g. a new primary cell or a new serving cell);
indication information indicating that the first cell is configured as a dormant cell;
indication information of the feedback resource corresponding to the first message; and
indication information of a first time interval, configured to determine the first time interval.

In the case that the first message carries the configuration information of the second cell, the configuration information of the second cell includes at least one of the following: the cell ID of the second cell and/or the cell index of the second cell, the SSB index and/or candidate SSB index of the second cell, the MIB of the second cell and/or the SIB1 of the second cell, other system message configurations of the second cell, the BWP configuration of the second cell, the subcarrier spacing configuration of the second cell, the CORESET configuration of the second cell, the SSS configuration of the second cell, the PDCCH configuration of the second cell, the pre-authorized resource configuration of the second cell, the first RNTI of the second cell, the timing adjustment indication information of the second cell, and the uplink transmission waveform information of the second cell.

In some embodiments, the relationship between the coverage areas of the first cell and the second cell is at least one of the following:
the coverage areas of the first cell and the second cell being the same;
the coverage areas of the first cell and the second cell being different;
the coverage area of the first cell being larger than the coverage area of the second cell; and
the coverage area of the first cell being smaller than the coverage area of the second cell.

In some embodiments, the first cell and the second cell are same-frequency cells.

In some embodiments, the first cell and the second cell are different-frequency cells.

In some embodiments, the first cell and the second cell are both the serving cells of the apparatus. In some embodiments, the first cell and the second cell are different-frequency cells, or the first cell and the second cell are same-frequency cells.

In some embodiments, the first cell is the serving cell of the apparatus and the second cell is not the serving cell of the apparatus. In some embodiments, the first cell and the second cell are different-frequency cells, or the first cell and the second cell are same-frequency cells.

In some embodiments, the first cell and the second cell are provided by the same network device, or the first cell and the second cell are provided by different network devices.

In some embodiments, the first message is a system message; or, the first message is a MAC CE message; or, the first message is an RRC message; or, the first message is a DCI message.

In some embodiments, the first message is a broadcast message, a multicast message, or UE-specific signaling.

A sending module 902 is configured to send a second message (or referred to as a first confirmation command) after receiving the first message. The second message is configured to confirm that the first message has been received.

In some embodiments, the second message includes an ACK message.

In some embodiments, the second message includes ACK information or NACK information.

In some embodiments, the second message is UCI, where the second message is transmitted through a PUCCH, or the second message is transmitted through a PUSCH, for example, the second message is transmitted in the form that the UCI is multiplexed to the PUSCH. In some embodiments, the PUSCH is a DCI-scheduled PUSCH or a CG-PUSCH.

In some embodiments, the second message is a MAC CE or RRC message. In some embodiments, the second message is transmitted through a PUSCH. In some embodiments, the PUSCH is a DCI-scheduled PUSCH or a CG-PUSCH.

In some embodiments, the first cell and the second cell are both uplink cells, and the second message is transmitted over the first cell; or, the second message is transmitted over the second cell; or, the second message is transmitted over a fourth cell, and the fourth cell is an uplink cell except the first cell and the second cell.

A processing module 903 is configured to, based on the first message, reconfigure the primary cell from the first cell to the second cell, or no longer configure the first cell as the primary cell; and/or configure the second cell as the primary cell; or, configured to, based on the first message, reconfigure the serving cell from the first cell to the second cell, or no longer configure the first cell as the serving cell; and/or configure the second cell as the serving cell.

In some embodiments, the first cell and the second cell are both the serving cells of the apparatus. After the receiving module 901 receives the first message, the processing module 903 reconfigures the primary cell of the apparatus from the first cell to the second cell, or no longer configures the first cell as the primary cell; and/or configures the second cell as the primary cell.

In some embodiments, the first cell is the serving cell of the apparatus and the second cell is not the serving cell of the apparatus. After the receiving module 901 receives the first message, the processing module 903 reconfigures the serving cell of the apparatus from the first cell to the second cell, or no longer configures the first cell as the serving cell; and/or configures the second cell as the serving cell.

In some embodiments, for example in a DC network deployment scenario, the primary cell includes the PCell in the MCG, and/or the PSCell in the SCG.

In some embodiments, in the case that the first time interval has elapsed since the transmission of the second message, the processing module 903 configures or reconfigures the primary cell of the apparatus from the first cell to the second cell.

The starting point of the first time interval is the moment when the apparatus transmits the second message or the moment when the transmission of the second message ends, where the second message is transmitted after the receiving module 901 receives the first message, and is configured to confirm that the first message has been received.

In some embodiments, the first time interval is predefined for communication, or the first time interval is determined based on the configuration information of the network device. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.

In some embodiments, the processing module 903 deactivates the first cell or configures the first cell as a dormant cell.

In some embodiments, the processing module 903 monitors a PDCCH on an activated BWP of the second cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the reconfiguration process, the network device and the apparatus both reserve some contexts, such as the C-RNTI of the first cell, such that the apparatus still considers the first cell as the primary cell in the case of a configuration or reconfiguration failure.

In some embodiments of the present disclosure, the second cell includes a downlink cell and/or an uplink cell. Alternatively, the primary cell reconfigured by the network device includes a downlink cell and/or an uplink cell.

In some embodiments of the present disclosure, the BWP configuration of the second cell is configured to determine at least one of the following information: a downlink BWP configuration, an uplink BWP configuration, a downlink BWP ID, and an uplink BWP ID of the second cell. In some embodiments, the downlink BWP includes a downlink activated BWP and/or a downlink configured BWP. In some embodiments, the uplink BWP includes an uplink activated BWP and/or an uplink configured BWP. For example, the BWP configuration information includes the ID of the downlink activated BWP and the configuration of the downlink activated BWP, where the downlink activated BWP configuration includes the indication of the starting position and the length of the BWP, and the apparatus determines the ID of the downlink activated BWP and the bandwidth of the downlink activated BWP based on the BWP configuration information.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the apparatus monitors the PDCCH on the second cell and/or receives downlink transmission on the first cell based on the downlink subcarrier spacing determined by the subcarrier spacing configuration. For another example, the apparatus transmits the PUSCH and/or PUCCH and/or semi-persistent scheduling (SRS) based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the apparatus monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the resource block (RB) occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., transmission configuration indicator (TCI) information, and/or quasi-co-location (QCL) reference signal information, and/or quasi-co-location type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the demodulation reference signal (DMRS) parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink hybrid automatic repeat request (HARQ) process number, the period of the pre-authorized resource, the number of repetitions using the pre-authorized resource for transmission, the corresponding redundancy version (RV) of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the modulation and coding scheme (MCS) and transport block size (TBS) indication, the SRS resource indication, the frequency domain hopping offset indication, and the path loss reference indication.

It should be understood that in the embodiments of the present disclosure, time units of the second cell is an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a configured scheduling RNTI (CS-RNTI) of the second cell.

In some embodiments of the present disclosure, the timing adjustment indication information of the second cell is a time advance (TA) command.

In some embodiments of the present disclosure, the uplink transmission waveform information of the second cell is configured to determine whether a discrete Fourier transform (DFT) precoder is used (or whether the waveform used is an orthogonal frequency division multiplexing (OFDM) waveform or a DFT-S-OFDM waveform) when the apparatus device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-spread OFDM (DFT-S-OFDM) waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

FIG. 12 shows a structural block diagram of an apparatus for configuring or reconfiguring a primary cell according to some schematic embodiments of the present disclosure. The apparatus includes the following modules.

A sending module 1001 is configured to send a first message.

The first message is sent by the apparatus for the energy savings. The first message is sent in the case that the apparatus determines to employ the energy-saving mode for the first cell. In some embodiments, the first message is sent in the case that the apparatus determines to turn off the first cell, or the first message is sent in the case that the apparatus determines to configure the first cell as an inactive cell, or the first message is sent in the case that the apparatus determines to configure the first cell as a dormant cell, or the first message is sent in the case that the apparatus determines to transmit only basic common signals over the first cell. Namely, the first cell is a cell that is determined to employ the energy-saving mechanism, or the first cell is a cell that is about to employ the energy-saving mechanism, or the first cell is a cell that employs the energy-saving mechanism after a time interval x, x being configured or predefined by the apparatus. The starting point of the time interval is the moment when the terminal starts transmitting the second message or the moment when the transmission of the second message ends, where the second message is sent after the terminal receives the first message, and is configured to confirm that the first message has been received.

In some embodiments, the first message indicates that the terminal configures or reconfigures the primary cell from the first cell to the second cell; or, the first message indicates that the terminal no longer configures the first cell as the primary cell; or, the first message indicates that the terminal configures the second cell as the primary cell.

In some embodiments, the first message indicates that the terminal configures or reconfigures the serving cell from the first cell to the second cell; or, the first message indicates that the terminal no longer configures the first cell as the serving cell; or, the first message indicates that the terminal configures the second cell as the serving cell.

In some embodiments, the terminal has the CA or DC capability. The first cell is the primary cell of the terminal, the second cell is the secondary cell of the terminal, and the two cells both serve as the serving cell of the terminal.

In some embodiments, the terminal does not have the CA or DC capability, or the terminal has the CA or DC capability but does not enable CA or DC. The first cell is the primary cell or the serving cell of the terminal. The second cell is a neighbor cell of the terminal.

In some embodiments, the first message includes at least one of the following:
indication information indicating that the first cell is no longer configured as the primary cell or the serving cell;
indication information indicating that the second cell is configured as the primary cell or the serving cell;
indication information for initiating the reconfiguration of the primary cell or the serving cell;
configuration information of the second cell (e.g. a new primary cell or a new serving cell);
indication information indicating that the first cell is configured as a dormant cell;
indication information of the feedback resource corresponding to the first message; and
indication information of a first time interval, configured to determine the first time interval.

In the case that the first message carries the configuration information of the second cell, the configuration information of the second cell includes at least one of the following: the cell ID of the second cell and/or the cell index of the second cell, the SSB index and/or candidate SSB index of the second cell, the MIB of the second cell and/or the SIB1 of the second cell, other system message configurations of the second cell, the BWP configuration of the second cell, the subcarrier spacing configuration of the second cell, the CORESET configuration of the second cell, the SSS configuration of the second cell, the PDCCH configuration of the second cell, the pre-authorized resource configuration of the second cell, the first RNTI of the second cell, the timing adjustment indication information of the second cell, and the uplink transmission waveform information of the second cell.

In some embodiments, the first message is a system message; or, the first message is a MAC CE message; or, the first message is an RRC message; or, the first message is a DCI message.

In some embodiments, the first message is a broadcast message, a multicast message, or UE-specific signaling.

A receiving module 1002 is configured to receive a second message (or referred to as a first confirmation command) after the sending module 1001 sends the first message. The second message is configured to confirm that the first message has been received.

In some embodiments, the second message includes an ACK message.

In some embodiments, the second message includes ACK information or NACK information.

In some embodiments, the second message is UCI, where the second message is transmitted through a PUCCH, or the second message is transmitted through a PUSCH, for example, the second message is transmitted in the form that the UCI is multiplexed to the PUSCH. In some embodiments, the PUSCH is a DCI-scheduled PUSCH or a CG-PUSCH.

In some embodiments, the second message is a MAC CE or RRC message. In some embodiments, the second message is transmitted through a PUSCH. In some embodiments, the PUSCH is a DCI-scheduled PUSCH or a CG-PUSCH.

In some embodiments, the first cell and the second cell are both uplink cells, and the second message is transmitted over the first cell; or, the second message is transmitted over the second cell; or, the second message is transmitted over a fourth cell, and the fourth cell is an uplink cell except the first cell and the second cell.

A processing module 1003 is configured to, based on the first message, reconfigure the primary cell from the first cell to the second cell, or no longer configure the first cell as the primary cell; and/or configure the second cell as the primary cell; or, configured to, based on the first message, reconfigure the serving cell from the first cell to the second cell, or no longer configure the first cell as the serving cell; and/or configure the second cell as the serving cell.

In some embodiments, the first cell and the second cell are both the serving cells of the terminal. The processing module 1003 reconfigures the primary cell of the terminal from the first cell to the second cell, or no longer configures the first cell as the primary cell; and/or configures the second cell as the primary cell.

In some embodiments, the first cell is the serving cell of the terminal and the second cell is not the serving cell of the terminal. The processing module 1003 reconfigures the serving cell of the terminal from the first cell to the second cell, or no longer configures the first cell as the serving cell; and/or configures the second cell as the serving cell.

In some embodiments, for example in a DC network deployment scenario, the primary cell includes the PCell in the MCG, and/or the PSCell in the SCG.

In some embodiments, in the case that the first time interval has elapsed since the receiving of the second message, the processing module 1003 configures or reconfigures the primary cell of the terminal from the first cell to the second cell.

The starting point of the first time interval is the moment when the terminal transmits the second message or the moment when the transmission of the second message ends, where the second message is transmitted after the terminal receives the first message, and is configured to confirm that the first message has been received.

In some embodiments, the first time interval is predefined for communication, or the first time interval is determined based on the configuration information of the apparatus. In some embodiments, the first time interval is associated with the subcarrier spacing configuration of the second cell; for example, the length of the first time interval is determined based on the subcarrier spacing of the second cell, and the subcarrier spacing configuration of a different second cell corresponds to a different first time interval. In some embodiments, the first time interval is associated with the subcarrier spacing configuration of the first cell; for example, the length of the first time interval is determined based on the subcarrier spacing of the first cell, and the subcarrier spacing configuration of a different first cell corresponds to a different first time interval. In some embodiments, the first time interval is associated with the subcarrier spacing configuration; for example, the length of the first time interval is determined based on the independently configured subcarrier spacing.

In some embodiments, the processing module 1003 deactivates the first cell or configures the first cell as a dormant cell.

In some embodiments, the processing module 1003 monitors a PDCCH on an activated BWP of the second cell.

In some embodiments, the relationship between the coverage areas of the first cell and the second cell is at least one of the following:
the coverage areas of the first cell and the second cell being the same;
the coverage area of the first cell being different from the coverage area of the second cell;
the coverage area of the first cell being larger than the coverage area of the second cell; and
the coverage area of the first cell being smaller than the coverage area of the second cell.

In some embodiments, during the reconfiguration process, the apparatus and the terminal both reserve some contexts, such as the C-RNTI of the first cell, such that the terminal still considers the first cell as the primary cell in the case of a configuration or reconfiguration failure.

In some embodiments of the present disclosure, the second cell includes a downlink cell and/or an uplink cell. Alternatively, the primary cell reconfigured by the apparatus includes a downlink cell and/or an uplink cell.

In some embodiments of the present disclosure, the BWP configuration of the second cell is configured to determine at least one of the following information: a downlink BWP configuration, an uplink BWP configuration, a downlink BWP ID, and an uplink BWP ID of the second cell. In some embodiments, the downlink BWP includes a downlink activated BWP and/or a downlink configured BWP. In some embodiments, the uplink BWP includes an uplink activated BWP and/or an uplink configured BWP. For example, the BWP configuration information includes the ID of the downlink activated BWP and the configuration of the downlink activated BWP, where the downlink activated BWP configuration includes the indication of the starting position and the length of the BWP, and the terminal determines the ID of the downlink activated BWP and the bandwidth of the downlink activated BWP based on the BWP configuration information.

In some embodiments of the present disclosure, the subcarrier spacing configuration of the second cell is configured to determine the subcarrier spacing configuration of the downlink BWP and/or the subcarrier spacing configuration of the uplink BWP of the second cell. In some embodiments, the downlink BWP includes a downlink activated BWP and/or a downlink configured BWP. In some embodiments, the uplink BWP includes an uplink activated BWP and/or an uplink configured BWP. For example, the terminal monitors the PDCCH on the second cell and/or receives downlink transmission on the first cell based on the downlink subcarrier spacing determined by the subcarrier spacing configuration. For another example, the terminal transmits the PUSCH and/or PUCCH and/or semi-persistent scheduling (SRS) based on the uplink subcarrier spacing determined by the subcarrier spacing configuration.

In some embodiments of the present disclosure, the PDCCH configuration information of the second cell is configured to determine the control-resource set configuration information and/or the search space set configuration information associated with the PDCCH. For example, the PDCCH configuration information indicates the control-resource set ID and/or the search space set ID associated with a PDCCH candidate when the terminal monitors the PDCCH candidate sent by the second cell. In some embodiments, the PDCCH configuration information is configured to determine the format of the PDCCH to be monitored, and/or the number of the PDCCH candidates to be monitored, and/or the aggregation level of the PDCCH to be monitored.

In some embodiments of the present disclosure, the control-resource set configuration information of the second cell is configured to determine at least one of the following information: the control-resource set ID of the second cell, the resource block (RB) occupied by the control-resource set in the frequency domain (e.g., the starting RB in the frequency domain, and/or the number of RBs occupied in the frequency domain, and/or RBs occupied in the frequency domain), the number of symbols occupied by the control-resource set in the time domain, and the quasi-co-location information associated with the control-resource set (e.g., transmission configuration indicator (TCI) information, and/or quasi-co-location (QCL) reference signal information, and/or quasi-co-location type).

In some embodiments of the present disclosure, the search space set configuration information of the second cell is configured to determine at least one of the following information: the search space set ID of the second cell, the control-resource set ID associated with the search space set, time units occupied by the search space set in the time domain (e.g., slots determined based on the monitoring slot period and offset configuration parameters), symbols occupied by the search space set in the occupied time unit (e.g., symbols determined based on the monitoring symbol configuration parameters in the slot), the type of search space set (e.g., a common search space set or a UE-specific search space set), the DCI format of the PDCCH candidate (e.g., DCI format 0_0 and/or DCI format 1_0), the aggregation level associated with the PDCCH candidate, and the number of blind monitoring occasions corresponding to the aggregation level of the PDCCH candidate.

In some embodiments of the present disclosure, the pre-authorized resource configuration of the second cell is configured to determine at least one of the following information: the pre-authorized resource configuration ID, the frequency domain hopping indication (e.g., indicating whether frequency hopping occurs, or indicating frequency hopping within a time unit or frequency hopping between time units), the demodulation reference signal (DMRS) parameter configuration (e.g., configured to determine the location of a DMRS in the pre-authorized resource), the frequency domain resource allocation type (e.g., configured to determine what type the frequency domain resource allocation is based on, e.g., type 0, type 1, or type 2 allocation), the uplink transmission waveform information, the pre-configured uplink hybrid automatic repeat request (HARQ) process number, the period of the pre-authorized resource, the number of repetitions using the pre-authorized resource for transmission, the corresponding redundancy version (RV) of the repeated transmission using the pre-authorized resource, the time unit occupied by the pre-authorized resource in the time domain (e.g., determining the slot occupied by the pre-authorized resource in the time domain based on the time domain offset), the starting symbol and the number of symbols occupied by the pre-authorized resource in the occupied time unit (e.g., determining the starting symbol and the number of symbols occupied by the pre-authorized resource in the occupied slot based on the time domain resource allocation information), the RB occupied by the pre-authorized resource in the frequency domain (e.g., determining the RB occupied by the pre-authorized resource in the frequency domain based on the frequency domain resource allocation parameters and the frequency domain resource allocation type), the antenna port, the DMRS sequence initialization parameter, the precoding and layer number indication, the modulation and coding scheme (MCS) and transport block size (TBS) indication, the SRS resource indication, the frequency domain hopping offset indication, and the path loss reference indication.

It should be understood that in the embodiments of the present disclosure, time units of the second cell is an integer number of symbols, slots, subframes, half-frames, or frames, which is not limited in the present disclosure.

In some embodiments of the present disclosure, the first RNTI is a C-RNTI of the second cell; or the first RNTI is an MCS-C-RNTI of the second cell; or, the first RNTI is a configured scheduling RNTI (CS-RNTI) of the second cell.

In some embodiments of the present disclosure, the timing adjustment indication information of the second cell is a time advance (TA) command.

In some embodiments of the present disclosure, the uplink transmission waveform information of the second cell is configured to determine whether a discrete Fourier transform (DFT) precoder is used (or whether the waveform used is an orthogonal frequency division multiplexing (OFDM) waveform or a DFT-S-OFDM waveform) when the terminal device performs uplink transmission to the first cell. For example, the uplink transmission waveform information is a transform precoder, and in the case that the transform precoder is configured to be enabled, the uplink transmission waveform information indicates that the DFT precoder (or the corresponding DFT-spread OFDM (DFT-S-OFDM) waveform) is used during uplink transmission; in the case that the transform precoder is configured to be disabled, the uplink transmission waveform information indicates that the DFT precoder (or the corresponding OFDM waveform) is not used during uplink transmission.

In some embodiments, in the case that the uplink transmission waveform information is not configured, the default uplink transmission waveform is to use a DFT precoder (or the corresponding DFT-S-OFDM waveform) during uplink transmission.

In some embodiments, in the case that the uplink transmission waveform information is not configured, the default uplink transmission waveform is to not use the DFT precoder (or the corresponding OFDM waveform) during uplink transmission.

It should be noted that for the apparatus for configuring or reconfiguring a primary cell according to the above embodiments, the division of the functional modules is merely exemplary. In the practical application, the above functions can be assigned to different functional modules as needed, that is, the internal structure of the device may be divided into different functional modules, so as to implement all or part of the above functions.

With regard to the apparatus in the embodiments, the specific manner in which each module performs the operation has been described in detail in the embodiments related to the method and will not be described in detail herein.

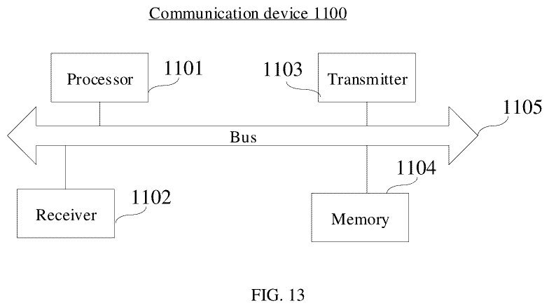

FIG. 13 shows a schematic structural diagram of a communication device (a terminal device or a network device) according to some embodiments of the present disclosure. The communication device 1100 includes: a processor 1101, a receiver 1102, a transmitter 1103, a memory 1104, and a bus 1105.

The processor 1101 includes one or more processing cores, and the processor 1101 performs various functional applications and information processing by running software programs and modules.

The receiver 1102 and the transmitter 1103 are implemented as a communication assembly, which may be a communication chip.

The memory 1104 is connected to the processor 1101 through the bus 1105. The memory 1104 is configured to store at least one instruction, and the processor 1101 is configured to execute the at least one instruction to perform the processes in the above method embodiments.

In addition, the memory 1104 may be implemented using any type of non-transitory or non-transitory storage device, or a combination of both. Transitory or non-transitory storage devices include, but are not limited to: magnetic or optical disks, electrically erasable programmable read-only memory (EEPROM), erasable programmable read-only memory (EPROM), static random-access memory (SRAM), read-only memory (ROM), magnetic memory, flash memory, and programmable read-only memory (PROM).

In some exemplary embodiments, a computer-readable storage medium is further provided. The computer-readable storage medium stores at least one instruction, at least one program, a code set, or an instruction set therein. The at least one instruction, the at least one program, the code set, or the instruction set, when loaded and executed by the processor, causes the processor to perform the method for configuring or reconfiguring a primary cell according to the above method embodiments.

In some exemplary embodiments, a chip is further provided. The chip includes one or more programmable logic circuits and/or one or more program instructions. The chip, when running on the communication device, is caused to perform the method for configuring or reconfiguring a primary cell according to the above method embodiments.

In some exemplary embodiments, a computer program product is further provided. The computer program product, when running on a processor of a computer device, causes the computer device to perform the method for configuring or reconfiguring a primary cell.

Those skilled in the art should appreciate that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium may be any available medium that is accessible by a general-purpose or special-purpose computer.

Described above are merely optional embodiments of the present disclosure and are not intended to limit the present disclosure. Any modifications, equivalents, improvements, and the like, made within the spirit and principle of the present disclosure should fall within the protection scope of the present disclosure.

1. A method for configuring or reconfiguring a primary cell, applicable to a terminal, the method comprising:
receiving a first message; and
configuring or reconfiguring the primary cell of the terminal from a first cell to a second cell based on the first message.

2. The method according to claim 1, wherein the first message indicates at least one of:
a situation where the terminal configures or reconfigures the primary cell from the first cell to the second cell; a situation where the terminal no longer configures the first cell as the primary cell; or a situation where the terminal configures the second cell as the primary cell.

3. The method according to claim 1, further comprising at least one of:
configuring the first cell as a deactivated cell; or
configuring the first cell as a dormant cell.

4. The method according to claim 1, wherein the first message comprises at least one of:
indication information indicating that the first cell is no longer configured as the primary cell;
indication information indicating that the first cell is configured as a deactivated cell or a dormant cell;
indication information indicating that the second cell is configured as the primary cell;
indication information for initiating reconfiguration of the primary cell;
indication information of a feedback resource corresponding to the first message, wherein the feedback resource corresponding to the first message is configured to transmit feedback information corresponding to the first message;
determination information of a first time interval, wherein the determination information of the first time interval is configured to determine the first time interval, and the first time interval is configured to determine an effective time for configuring or reconfiguring the primary cell as the second cell; or
configuration information of the second cell.

5. The method according to claim 1, wherein the first cell and the second cell are downlink cells; and configuring or reconfiguring the primary cell of the terminal from the first cell to the second cell based on the first message comprises:
configuring or reconfiguring a downlink primary cell of the terminal from the first cell to the second cell based on the first message.

6. The method according to claim 5, wherein receiving the first message comprises at least one of:
receiving the first message over the first cell;
receiving the first message over the second cell; or
receiving the first message over a third cell, wherein the third cell is another downlink cell except the first cell and the second cell.

7. The method according to claim 1, wherein the first cell and the second cell are uplink cells; and configuring or reconfiguring the primary cell of the terminal from the first cell to the second cell based on the first message comprises:
configuring or reconfiguring an uplink primary cell of the terminal from the first cell to the second cell based on the first message.

8. The method according to claim 1, wherein there is at least one of:
the first message is a system message;
the first message is a media access control (MAC) control element (CE) message;
the first message is a cell-common radio resource control (RRC) configuration message;
the first message is a radio resource control (RRC) configuration message dedicated to the terminal; or
the first message is a downlink control information (DCI) message.

9. The method according to claim 1, further comprising:
reserving a context of the first cell during a configuration or reconfiguration process.

10. A method for configuring or reconfiguring a primary cell, applicable to a network device, the method comprising:
sending a first message, wherein the first message indicates that a primary cell of a terminal is configured or reconfigured from a first cell to a second cell.

11. A terminal, wherein the terminal comprises:
a processor;
a transceiver, connected to the processor; and
a memory, configured to store one or more executable instructions of the processor;
wherein the processor, when loading and executing the one or more executable instructions, is caused to perform:
receiving a first message; and
configuring or reconfiguring the primary cell of the terminal from a first cell to a second cell based on the first message.

12. The terminal according to claim 11, wherein the first message indicates at least one of:
a situation where the terminal configures or reconfigures the primary cell from the first cell to the second cell; a situation where the terminal no longer configures the first cell as the primary cell; or a situation where the terminal configures the second cell as the primary cell.

13. The terminal according to claim 11, wherein the processor, when loading and executing the one or more executable instructions, is further caused to perform at least one of:
configuring the first cell as a deactivated cell; or
configuring the first cell as a dormant cell.

14. The terminal according to claim 11, wherein the first message comprises at least one of:
indication information indicating that the first cell is no longer configured as the primary cell;
indication information indicating that the first cell is configured as a deactivated cell or a dormant cell;
indication information indicating that the second cell is configured as the primary cell;
indication information for initiating reconfiguration of the primary cell;
indication information of a feedback resource corresponding to the first message, wherein the feedback resource corresponding to the first message is configured to transmit feedback information corresponding to the first message;
determination information of a first time interval, wherein the determination information of the first time interval is configured to determine the first time interval, and the first time interval is configured to determine an effective time for configuring or reconfiguring the primary cell as the second cell; or
configuration information of the second cell.

15. The terminal according to claim 11, wherein the first cell and the second cell are downlink cells; and the processor, when loading and executing the one or more executable instructions, is caused to perform:
configuring or reconfiguring a downlink primary cell of the terminal from the first cell to the second cell based on the first message.

16. The terminal according to claim 15, wherein the processor, when loading and executing the one or more executable instructions, is caused to perform at least one of:
receiving the first message over the first cell;
receiving the first message over the second cell; or
receiving the first message over a third cell, wherein the third cell is another downlink cell except the first cell and the second cell.

17. The terminal according to claim 11, wherein the first cell and the second cell are uplink cells; and the processor, when loading and executing the one or more executable instructions, is caused to perform:
configuring or reconfiguring an uplink primary cell of the terminal from the first cell to the second cell based on the first message.

18. The terminal according to claim 11, wherein there is at least one of:
the first message is a system message;
the first message is a media access control (MAC) control element (CE) message;
the first message is a cell-common radio resource control (RRC) configuration message;
the first message is a radio resource control (RRC) configuration message dedicated to the terminal; or
the first message is a downlink control information (DCI) message.

19. The terminal according to claim 11, wherein the processor, when loading and executing the one or more executable instructions, is further caused to perform:
reserving a context of the first cell during a configuration or reconfiguration process.

20. A network device, wherein the network device comprises:
a processor;
a transceiver, connected to the processor; and
a memory, configured to store one or more executable instructions of the processor;
wherein the processor, when loading and executing the one or more executable instructions, is caused to perform the method for configuring or reconfiguring the primary cell as defined in claim 10.
